(19) United States
(12) Patent Application Publication
(10) Pub. No.: US 2013/0310987 A1
(43) Pub. Date: Nov. 21, 2013

(54) BUILDING AUTOMATION SYSTEM

(71) Applicants: Werner Sobek, Stuttgart (DE); Walter Haase, Hildrizhausen (DE); Jonathan Busse, Stuttgart (DE); Christoph Witte, Stuttgart (DE)

(72) Inventors: Werner Sobek, Stuttgart (DE); Walter Haase, Hildrizhausen (DE); Jonathan Busse, Stuttgart (DE); Christoph Witte, Stuttgart (DE)

(73) Assignee: alphaEOS AG, Stuttgart (DE)

(21) Appl. No.: 13/884,023

(22) PCT Filed: Nov. 7, 2011
(86) PCT No.: PCT/EP2011/005589

§ 371 Date: Jul. 22, 2013

(30) Foreign Application Priority Data
Nov. 8, 2010 (DE) 10 2010 050 726.1

(51) Int. Cl. G05D 23/19

(52) U.S. Cl. CPC G05D 23/19
USPC 700/276

(57) ABSTRACT

The invention relates to a method of operation for a building automation system comprising the provision and/or collection of at least one piece of information which describes at least one time involvement and/or energy involvement provided in order to attain at least one particular building zone climate and/or at least one particular building zone climate change, using the at least one piece of information in order to ascertain at least one requisite time involvement and/or energy involvement in order to attain at least one building zone climate that is to be achieved and/or at least one building zone climate change that is to be achieved, and/or using the at least one piece of information in order to ascertain at least one measure for influencing the building zone climate, which measure can be used to attain at least one building zone climate that is to be achieved and/or at least one building zone climate change that is to be achieved in time-optimized and/or energy-optimized fashion or to attain it/them with a preference which can be prescribed by the user. The invention also relates particularly to an appropriate building automation system and an appropriate computer program.

The invention relates to an operating method for a building automation system and a corresponding building automation system, control system, computer program, computer program product, computer-readable product and a corresponding computer or a corresponding data processing unit such as a micro-controller or a processor.

Control systems are known from the prior art for house or building automation systems which can appropriately adapt the one or more room climate parameters to the desires of the users or centrally defined requirements.

One disadvantage with the known control systems is that not all theoretically possible measures or combinations of measures for influencing the room climate are taken into account and are usable. There is mostly just one dedicated control circuit for each room climate parameter. For example, the heating control circuit detects the actual temperature, queries what a desired temperature should be and instigates a measure such as heating or cooling in order to bring the actual value in line with the desired value. If, for example, it is determined that the desired value has been exceeded, the corresponding counter-measure is instigated (cooling). The fact that there may be other measures which can be taken which contribute to an energy-efficient solution of the problem (e.g. shading) is not taken into account. Therefore, conventional building automation systems often do not work energy-efficiently since the measures which are necessary for influencing the room climate are executed in a poorly coordinated or totally uncoordinated way.

Furthermore, conventional control systems do not detect the time and energy required to achieve and maintain a desired building zone climate. Therefore, it is not possible to decide with conventional control systems whether a room should be conditioned in a particularly energy-efficient way or particularly quickly.

In order to achieve good energy saving values with conventional control systems the control systems must be programmed and parameterized in a building-specific manner (e.g. alignment, shading, thermal inertia, etc.). The parameters must be determined using a complex and costly simulation process.

In light of the above explanations it is clear to the persons skilled in the art on the basis of this disclosure that there is a requirement to solve or overcome the above described problems or disadvantages. This invention relates to this requirement of the prior art and to other requirements, which are revealed to persons skilled in the art based on this disclosure.

The objects arising from the aforementioned can be achieved in particular with the features of the independent claims. The invention is not limited, however, to embodiments that remedy all of the problems or disadvantages of the prior art cited at the outset. The invention also claims general protection for the exemplary embodiments according to the invention described below.

According to the invention an operating method for a building or house automation system is provided, for example for air conditioning of at least one building zone and/or for controlling (e.g. open loop or closed loop controlling) or monitoring of at least one measure for influencing the building zone climate or at least one functional means (e.g. sensors, electric consumers, functional units, etc.) of the building automation system and/or for preferably sensory detection of parameters which describe the building zone climate (indoor climate) or the outdoor climate.

In a preferred exemplary embodiment it is possible that at least one information (in particular an empirical information and/or building zone climate behavior information, hereinafter referred to as empirical information) is provided (in particular determined) and/or collected (preferably saved) which describes at least one performed (used) time expenditure for obtaining or maintaining at least one specific building zone climate and/or at least one specific building zone climate change.

It is furthermore possible that at least one information (in particular an empirical information and/or building zone climate behavior information, hereinafter referred to as empirical information) is provided (in particular determined) and/or collected (preferably saved) which describes at least one performed (used) energy expenditure for obtaining or maintaining at least one specific building zone climate and/or at least one specific building zone climate change.

It is possible that at least one (anticipated) required time expenditure for obtaining or maintaining at least one building zone climate to be achieved or already achieved and/or at least one building zone climate change to be achieved or already achieved is determined (in particular calculated) and preferably displayed. Furthermore, it is possible that at least one (anticipated) required energy expenditure for obtaining or maintaining at least one building zone climate to be achieved or already achieved and/or at least one building zone climate change to be achieved or already achieved is determined (in particular calculated) and preferably displayed. The determination is carried out using the at least one empirical information.

By means of the invention, it is possible, in an advantageous way, for a required energy expenditure and/or time expenditure to be determined in order to at least obtain one building zone climate to be achieved and/or at least one building zone climate change to be achieved, resp. in order to maintain at least one achieved building zone climate and/or at least one achieved building zone climate change.

It is preferably possible to determine (in particular calculate) and preferably display at least one measure for influencing the building zone climate by means of which at least one building zone climate to be achieved or already achieved and/or at least one building zone climate change to be achieved or already achieved can be obtained or maintained in a time-optimized manner (preferably as fast as possible) and/or in an energy-optimized manner (preferably with as less energy expenditure as possible). Furthermore, it is preferably possible to determine (in particular calculate) and preferably display at least one measure for influencing the building zone climate by means of which at least one building zone climate to be achieved or already achieved and/or at least one building zone climate change to be achieved or already achieved can be obtained or maintained with a user-prescribable preference. The determination is carried out using the at least one empirical information.

Through use of the invention it is possible, in an advantageous way, to determine at least one measure for influencing the building zone climate with which at least one building zone climate to be achieved and/or at least one building zone climate change to be achieved is obtainable or at least one achieved building zone climate and/or at least one achieved building zone climate change is maintainable.

The user-prescribable preference is preferably an energy/time preference or a preference which comprises an energy/time weighting.

The user-prescribable preference can, in particular, comprise a time-efficiency related and/or an energy-efficiency related preference. For example, the preference can comprise a weighting with respect to time-efficiency and/or energy efficiency (e.g. 100% energy-efficient (energy-optimized) and 0% time-efficient, 80% energy-efficient and 20% time-efficient, 50% energy-efficient and 50% time-efficient, or 0% energy-efficient and 100% time-efficient (time-optimized)).

The user-prescribable preference can therefore preferably be a compromise concerning an energy-optimized procedure and/or a time-optimized procedure, but can also comprise the energy-optimized and/or the time-optimized procedure.

The user can, furthermore, in an advantageous manner, select before or during operation between an energy-optimized (or at least relatively energy-efficient) or a time-optimized (or at least relatively quick) or an intermediate fulfillment of the building zone climate to be achieved.

By means of the invention, energy-efficient action can consciously be promoted and simultaneously the feeling relativized of being dominated by a system since, if applicable, a user decision can be made before in favor of an energy-efficient or even energy-optimized operation.

The “building zone climate” will be referred to in the following in individual cases instead of “building zone climate and/or building zone climate change”, wherein however, alternatively or additionally, the “building zone climate change” is also included.

The climate in the sense of the invention can comprise or describe at least one of the following: air temperature, brightness, preferably relative air humidity, carbon dioxide concentration, surface temperature of at least one building zone delimitation (e.g. a wall, ceiling and/or a floor), wind force, cloudiness, solar irradiation, light intensity, luminance, air flow velocity. The climate can be assigned corresponding to the building zone climate (indoor climate) and/or to the outdoor climate.

The climate can comprise one or more climatic parameters or one or more climatic values (e.g. air temperature 20°, relative air humidity rF 60%). In this way the climate in the sense of the invention, can comprise a single climatic parameter or a plurality of climatic parameters.

The climate change can comprise a change in one or more climatic parameters or one or more climatic values.

In particular the specific building zone climate and/or the building zone climate to be achieved or already achieved in the sense of the invention comprises at least one of the following: at least one building zone climate desired value or at least one building zone climate desired parameter (preferably one dimensional), at least one building zone climate desired value range (preferably multi-dimensional), at least one building zone climate desired scenario which comprises at least two building zone climate desired parameters to be achieved. This also applies in a similar way, in particular, for the specific building zone climate change and/or that to be achieved.

The building zone climate to be achieved preferably refers to a building zone desired climate to be achieved in the future and the building zone climate achieved to an already achieved building zone climate, whereas the specific building zone climate preferably refers to a building zone desired climate achieved or maintained in the past. The same preferably applies to the building zone climate change to be achieved or already achieved and the specific building zone climate change.

It is possible, but not necessary, for the specific building zone climate mentioned in the providing or collecting step to be identical to the building zone climate to be achieved or already achieved mentioned in the determination step. This applies in a similar way, in particular, also for the specific building zone climate change mentioned in the providing or collecting step and the building zone climate change to be achieved or already achieved mentioned in the determination step and, in particular, the possibly mentioned given marginal conditions and measures for influencing the building zone climate.

The building zone preferably comprises one or more inside rooms and can, for example, furthermore comprise an apartment or a whole building or house.

Through the step of providing and/or collecting the at least one empirical information the climatic behavior of the building zone can advantageously be determined or (preferably continuously) empirically learned taking account of given and/or changing marginal conditions and/or taking account of or assignment of at least one effect from at least one measure for influencing the building zone climate.

The marginal conditions can be building zone specific (for example thermal inertia, location, window surfaces, room height, etc.), building automation system specific (for example energy consumption, performance capability, efficiency etc. of at least one measure for influencing the building zone climate or other functional means) and/or be climate-specific (e.g. external temperature, internal temperature, etc.).

The step of determination is performed using the at least one empirical information, as a result of which advantageously the (in particular empirical) climatic behavior of the building zone can be included, in particular taking account of given or changing marginals conditions and preferably taking account of or assignment of at least one effect of at least one measure for influencing the building zone climate.

It is therefore, in turn, advantageously possible to determine how much time and/or energy is needed in order to obtain or maintain a building zone climate to be achieved and/or a building zone climate change to be achieved.

By means of the invention, it is therefore advantageously possible to compensate for the absence of certain building zone specific characteristic values and building automation specific characteristic values by using the empirical information. Conventionally it would be necessary, for example, to determine the building zone specific characteristic values and the building automation specific characteristic values in advance through use of extensive simulation models. Therefore one particular advantage of the invention is that no building zone specific parameters or control principles need to be programmed in or altered for installation or adaptation of the building automation system, in particular of its regulation or control system. This results in a lower installation expenditure which is associated with a cost reduction. Operation is more comfortable and user acceptance is also increased.

It is furthermore advantageous that all or at least a plurality of measures for influencing the building zone climate and, in particular, their interaction, can be taken into account during providing (or collecting) and/or determining. In this way a largest possible room for action is achieved in order to obtain the building zone climate to be achieved or to maintain an achieved building zone climate.

It is furthermore possible that the empirical information comprises the effectiveness of at least one measure for influencing the building zone climate (which, for example, is to be performed for obtaining a building zone climate to be achieved). The effectiveness of a measure for influencing the building zone climate is derivable, for example, from the change that this measure can affect on the building zone climate within a certain time. If the change rate of a measure and the behavior of the building zone under the given marginal conditions is known then the required time expenditure for obtaining a building zone climate to be achieved can be approximated.

The provision and/or collection in the sense of the invention comprises any means which is suitable to obtain the empirical information or to determine and/or to manage it or to store it.

One further advantage of the invention is that the building automation system, in particular its regulation or control system, is, in principle, universally applicable for virtually all building zones and buildings.

Advantageous, by means of the invention, the regulation or control functions can be automatically connected through learning-in of the respectively relevant sensors and measures (or actuators) for influencing the building zone climate, as a result of which the system is preferably scalable as necessary without the need for any additional installation or programming efforts.

The user can, furthermore, advantageously be informed before or during operation about the further required (and/or already performed) energy expenditure and the remaining (and/or already expired) time expenditure until a building zone climate to be achieved is obtained. This increases the comfort and the user acceptance.

By means of the invention it is possible, in an advantageous way, that a predictive and/or exact statement can be made concerning how much energy is needed for obtaining at least one building zone climate to be achieved or to maintain a building zone climate which has been achieved. This can, in particular, be achieved in that the energy consumption (e.g. wattage for the connected lighting) which must be expended to obtain this (that is, for example, heating 0-100% or activation of the sun screen) is detected, determined or manually entered and stored. Since the time expenditure of the at least one measure for influencing the building zone climate can be calculated, calculation of the whole energy consumption for obtaining the at least one building zone climate to be achieved is possible while taking account of the given marginal conditions.

The user can preferably prescribe a time (a point in time or time period) for obtaining the building zone climate to be achieved. In a simulation and evaluation process a strategy for selection and coordination of the at least one measure for influencing the building zone climate can be determined in order to obtain the building zone climate to be achieved under the given marginal conditions in a time-optimized, energy-optimized manner or taking into account of the intermediary preference prescribable by the user.

The (anticipated) required time expenditure is preferably a minimum time expenditure, whereas the (anticipated) required energy expenditure is preferably a minimum energy expenditure to obtain a building zone climate to be achieved or to maintain a building zone climate which has been achieved.

It is furthermore possible that a user prescribe information or user command information is taken into account or read-in.

The user command information can, for example, comprise the building zone climate to be achieved.

Also the user command information can, in particular, comprise the time (a point in time or time period) at which the building zone climate to be achieved is to be obtained.

Furthermore, the user command information can comprise whether the building zone climate to be achieved is to be obtained with the minimum time expenditure (resp. time-optimized) or with the minimum energy expenditure (resp. energy-optimized).

Also the user command information can comprise with which preference the building zone climate to be achieved is to be obtained or maintained. The preference can lie between the minimum time expenditure (resp. time-optimized) and the minimum energy expenditure (resp. energy-optimized) and can therefore represent an energy/time compromise.

By means of the invention it is possible that multiple different measures for influencing the building zone climate are determined with which the building zone climate to be achieved can preferably be obtained at a user-prescribable time.

The user command information can therefore preferably comprise which measure from a plurality of measures for influencing the building zone climate should be performed.

It is preferable that at least one measure for influencing the building zone climate is performed which is suitable to fulfill at least one user prescribed specification.

The user prescribed specification in particular comprises at least one of the following: the building zone climate to be achieved, the building zone climate change to be achieved, the preference, the time at which the building zone climate to be achieved and/or the building zone climate change to be achieved should be obtained, when at least one measure for influencing of the building zone climate should be performed.

The provision, collection and/or determination can at least temporarily take place during operation of the building automation system, at user-prescribable intervals or at user-prescribable times (points in time or time periods), when a single measure for influencing the building zone climate is performed and/or before or during performing of at least one measure for influencing the building zone climate. The determination is preferably performed iteratively, in particular by means of a finite iteration and/or evaluation method.

The building automation system can comprise at least one user presence sensor for detecting the presence or absence of a user.

The provision, collection and/or determination can furthermore, in particular, performed when there is no user in the building zone, which can advantageously be detected by the user presence sensor or is manually user-prescribable.

Evaluation of the at least one empirical information is, in particular, efficient when an individual measure or a change can be observed and detected under constant conditions. Since this is not always possible in the presence of the user, calibration of various measures can be performed during a phase of absence under the given marginal conditions.

The invention preferably comprises a procedure which, taking account of the already collected empirical information, decides whether the current actual climate or the current actual air conditioning can meaningfully add to the collection of empirical information and therefore should be recorded or not.

The more empirical information is available and, in particular, the larger the database which describes the previous climatic behavior of the building zone, the greater the accuracy of determination, for example of the energy expenditure, time expenditure and/or at least one measure for influencing the building zone climate, required to fulfill user prescribed specifications.

It is furthermore possible that at least one parameter (resp. value) is read in and/or detected preferably by means of at least one sensor, which describes the building zone climate and/or the outdoor climate.

It is also possible that at least one parameter (resp. value) is read in and/or detected preferably by means of at least one sensor, which describes the energy consumption, the air conditioning efficiency and/or the performance behavior of at least one measure for influencing the building zone climate.

It is furthermore possible for at least one parameter (resp. value) to be detected and/or read-in, which describes the status or the behavior of at least one measure for influencing the building zone climate (for example status values or behaviors of the actuators for the measures).

Furthermore, at least one parameter (resp. value), which describes an expected outdoor climate and/or building zone climate, can be read-in.

It is furthermore possible for weather data, weather forecast data and/or solar altitude data for the location of the building to be read in and/or, preferably automatically, retrieved or calculated.

The weather forecast data can, for example, comprise the external air temperature, wind force, air humidity and cloud cover expected at a specific time (point in time or time period).

It is furthermore possible that generally valid calendar data and/or user-specific calendar data are read in and/or preferably automatically retrieved.

The detecting, reading-in and/or retrieval can at least temporarily take place during operation of the building automation system, at user-prescribable intervals, at user-prescribable times (points in time or time periods), when a single measure for influencing the building zone climate is performed or before or during performing of at least one measure for influencing the building zone climate.

The detecting, reading-in and/or retrieval can furthermore, in particular, take place when there is no user in the building zone, which can advantageously be detected by means of the user presence sensor or is manually prescribable by the user.

The provision (or collection) and/or determination can, in particular, take place while taking account of at least one of the following: at least one parameter which describes the outdoor climate and/or the building zone climate, at least one parameter which describes the energy consumption, the air-conditioning efficiency and/or the performance behavior of at least one measure for influencing the building zone climate, at least one parameter which describes the status or the behavior of at least one measure for influencing the building zone climate, at least one parameter which describes an expected outdoor climate and/or building zone climate, weather data, weather forecast data, solar altitude data for the location of the building, generally valid and/or user-specific calendar data. The data or the parameters can be read-in, retrieved, detected for example by a sensor, calculated or can be provided in another suitable way.

It is particularly advantageous that a (anticipated) required time expenditure and/or energy expenditure can be determined in order to obtain at least one building zone climate to be achieved and/or at least one building zone climate change to be achieved until a user-prescribable time (a point in time or time period).

It is possible to determine a latest possible point in time at which at least one measure for influencing the building zone climate is to be activated or carried out, so that at least one building zone climate to be achieved is obtained at a user-prescribable time (point in time or time period), whereby superfluous climatic conditioning of the building zone is avoidable.

It is possible, in particular, to start at the latest possible point in time with air conditioning of the building zone and/or to determine at least one measure for influencing the building zone climate for the remaining time in order to obtain the at least one building zone climate to be achieved and/or the at least one building zone climate change, in a time-optimized and/or energy-optimized manner or with a user-prescribable preference.

It is, in particular, possible for at least one measure for influencing the building zone climate to be activated at the latest possible point in time, preferably automatically, or by means of user command information which can be read-in.

It is also possible to determine and preferably display how much time is remaining and/or how much energy is still required until a building zone climate to be achieved and/or a building zone climate change to be achieved is obtained.

It is possible that the at least one measure for influencing the building zone climate comprises a plurality of (for example different preferably counter influencing) measures (for example combinations of measures and/or a series of measures) which, for example, can be performed successively and/or simultaneously. It is, however, also possible that the at least one measure for influencing the building zone climate just comprises a single measure.

The at least one measure for influencing the building zone climate may comprise an air conditioning activity and/or an air conditioning means.

The at least one measure for influencing the building zone climate can, in particular, comprise at least one of the following: heating (increasing the building zone temperature), cooling (reducing the building zone temperature), ventilation, changing the shading conditions, changing the lighting conditions, changing the air humidity, changing the carbon dioxide concentration, heating means, air conditioning means, ventilation means, heat recovery means, shading means, lighting means, window opening/closing means. The at least one measure for influencing the building zone climate can furthermore comprise complete deactivation of certain air conditioning activities and/or air conditioning means (e.g. turning off the heating means, turning off the lighting means, etc.).

It is possible that at least one measure for influencing the building zone climate is carried out in order to obtain or to maintain the at least one building zone climate to be achieved or already achieved and/or the at least one building zone climate change to be achieved or already achieved in a time-optimized and/or energy-optimized manner or to obtain or to maintain it with a user-prescribable preference.

In order to obtain or maintain the at least one building zone climate to be achieved or already achieved and/or the at least one building zone climate change to be achieved or already achieved in a time-optimized manner and/or an energy-optimized manner or with a user-prescribable preference, it is possible that the operating method comprises the step of preferably autonomous and/or independent or automatic performing and/or adapting of at least one measure for influencing the building zone climate based on or reacting to at least one of the following: at least one preferably essentially currently detected marginal condition, at least one changing or at least essentially currently changed marginal condition, at least one effect of at least one measure for influencing the building zone climate, at least one detected and/or read-in parameter, read-in and/or retrieved weather data and/or weather forecast data, read-in and/or calculated solar altitude data, read-in and/or retrieved generally valid and/or user-specific calendar data, at least one user presetting.

Advantageously it is possible therefore for the operating method or the building automation system to react, for example, to one or more user interventions, in particular to (preferably manual) interventions by the user for changing the building zone climate (such as opening a window, actuation of the lighting, etc.).

It is possible that the operating method or the building automation system advantageously functions autonomously and/or independently or automatically, for example based on a user presetting or a user prescribed specification (for example an operating mode defined or selected in advance by the user or other prescribed specifications).

The marginal condition can relate to the building zone (for example user presence or absence, change(s) caused by user intervention(s), the building zone climate, an increase or decrease in the number of persons present, a CO2 change, etc.), can relate to the building automation system (for example change(s) caused by user intervention(s), measures for influencing the building zone climate, functional means, etc.) and/or can relate to the building zone climate or the outdoor climate (for example temperature changes, such as a drop in temperature or occasionally changing cloud cover, an increase or decrease in the number of persons, CO2 change, etc.). It is evident that a marginal condition can be assigned to multiple of the building zones, the building automation system and the building zone climate or outdoor climate.

It is possible that a plurality of or even all building zone climate parameters and/or a plurality of or even all measures for influencing the building zone climate and preferably a plurality of or all functional means or functional units are controlled (open looped resp. closed loop) and/or monitored by the same control circuit (open loop circuit resp. closed loop circuit) and/or monitoring circuit.

The regulation or controlling model according to the invention preferably comprises just the generally valid relationships, namely the effects and interactions of the measures (for example a heater switched on generates heat, natural ventilation ensures equalization of the inner and outer temperature, shading leads to darkening etc.). This basic framework of regulation knowledge is universally applicable for the room air conditioning and can therefore be applied independent of the location.

In particular building zone specific, location-specific and/or building automation specific marginal conditions can be detected during the installation or during operation and learned-in and, preferably, continuously refined.

It is possible, when a functional means (for example a sensor, air conditioning means, electric consumers, actuators, functional units, etc.) are adopted into the building automation system (for example connected with a regulator), that its function (for example measuring element, actuator or air conditioning element) is recognized and appropriately automatically embedded.

The invention is not limited to the operating method described above, but rather also comprises a building automation system and/or a control system (comprising a regulating system), in particular to carry out the operating method as described herein.

The system may be provided for air conditioning of at least one building zone and/or for controlling (e.g. open loop or closed loop controlling) or monitoring of at least one measure for influencing the building zone climate or at least one functional means (e.g. sensors, electric consumers, functional units, etc.) of the building automation system and/or for preferably sensory detection of parameters which describe the building zone climate (indoor climate) or the outdoor climate.

The system according to the invention may comprise a providing and/or collecting unit (e.g. a data base), which is configured to provide and/or collect at least one empirical information which describes at least one performed (used) time expenditure and/or energy expenditure for obtaining or maintaining at least one specific building zone climate and/or at least one specific building zone climate change.

The system may furthermore comprise a determining unit, which is configured to determine at least one (anticipated) required time expenditure and/or at least one (anticipated) required energy expenditure for obtaining or determining at least one building zone climate to be achieved or already achieved and/or at least one building zone climate change to be achieved or already achieved using the at least one empirical information.

Furthermore, the system may comprise a determining unit, which is configured to determine at least one measure for influencing the building zone climate by means of which at least one building zone climate to be achieved or already achieved and/or at least one building zone climate change to be achieved or already achieved can be obtained or maintained in a time-optimized and/or energy-optimized manner or can be obtained or maintained by a user-prescribable preference using the at least one empirical information.

The determining units (which preferably comprise computing units), can be a single determining unit. It is, however, also possible, that the determining units are two or more separate determining units. The same applies analogously for the remaining functional units or functional means (for example the read-in unit (s), the detecting unit(s) etc.) described herein.

The determining unit can additionally be configured as a control unit resp. open loop control and/or closed loop control unit. It is also possible, that a control unit resp. open loop control and/or closed loop control unit is provided (a unit separate to the determining unit).

The determining unit or control unit can preferably be provided for controlling (open loop or closed loop controlling) at least one air conditioning means or measure for influencing the building zone climate (or one or more other functional means), in particular so that the at least one building zone climate to be achieved or already achieved and/or the at least one building zone climate change to be achieved or already achieved is obtained or maintained in a time-optimized and/or energy-optimized manner or obtained or maintained with the user-prescribable preference.

It is possible that the system, in particular, comprises at least one measure or air conditioning means for influencing the building zone climate.

The functional units described herein can preferably be realized hardware-based as separate components or assemblies. There is, alternatively, also the option, however, that the respective functional means are realized as software module, for example in a computer program.

The invention furthermore comprises a computer program, in particular for a building or house automation system, preferably for air conditioning of at least one building zone and/or for controlling (e.g. closed loop or open loop controlling) or monitoring at least one measure for influencing the building zone climate or at least one functional means of the building automation system and/or for retrieval of parameters or values preferably detected by sensors which describe the building zone climate (indoor climate) or the outdoor climate.

The computer program is configured or formed in such a way that, when it is executed by a data processing unit (e.g. computer, processor, micro-controller, etc.) or a control or regulation system, it initiates execution of the steps of the operating method described herein.

Furthermore the invention comprises a computer, a data processing unit (comprising a processor or micro-controller), a control or regulation system or a computer-readable medium which includes a computer program as described herein.

Further features of the system and of the computer program are derivable directly from the method or system described herein.

The above features can be combined with one another in any desired manner. Other advantageous developments of the invention are disclosed in the sub-claims or are evident from the following description of preferred exemplary embodiments in conjunction with the attached figures. The figures show as follows:

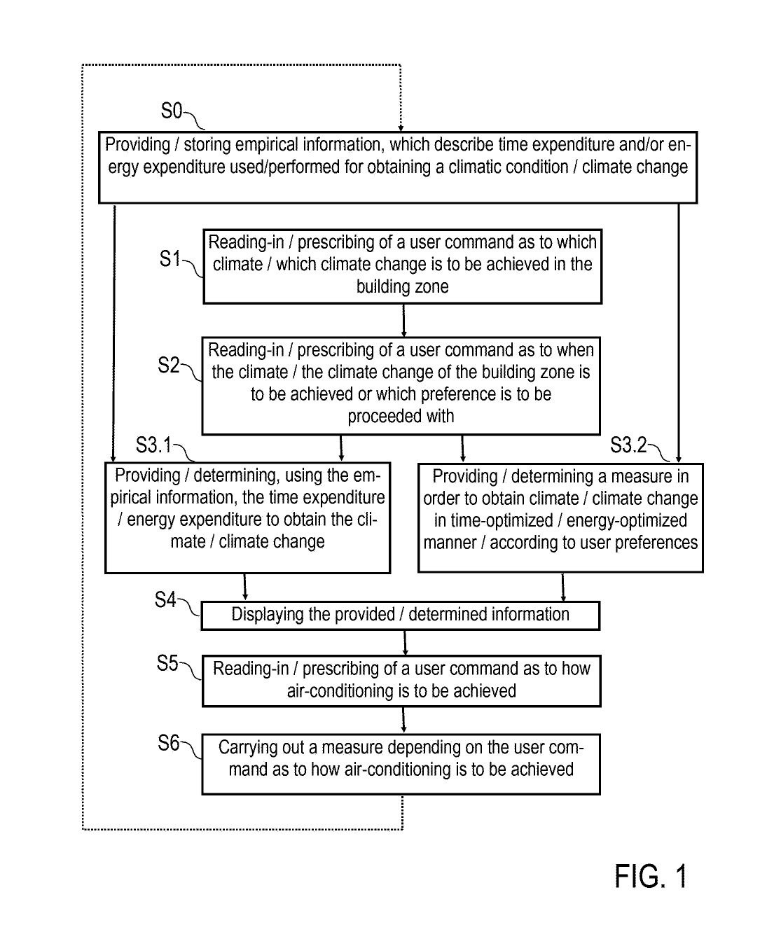

FIG. 1 an exemplary embodiment of an operating method according to the invention for a building or house automation system in the form of a flow chart,

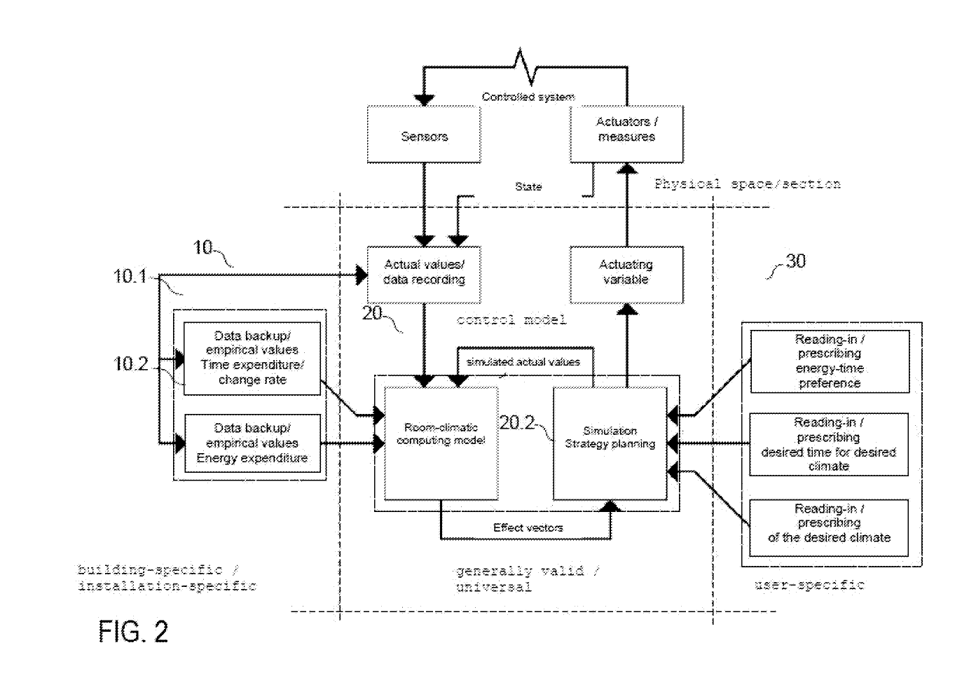

FIG. 2 a schematic representation for illustration of an exemplary embodiment of the operating method according to the invention and the building automation system according to the invention,

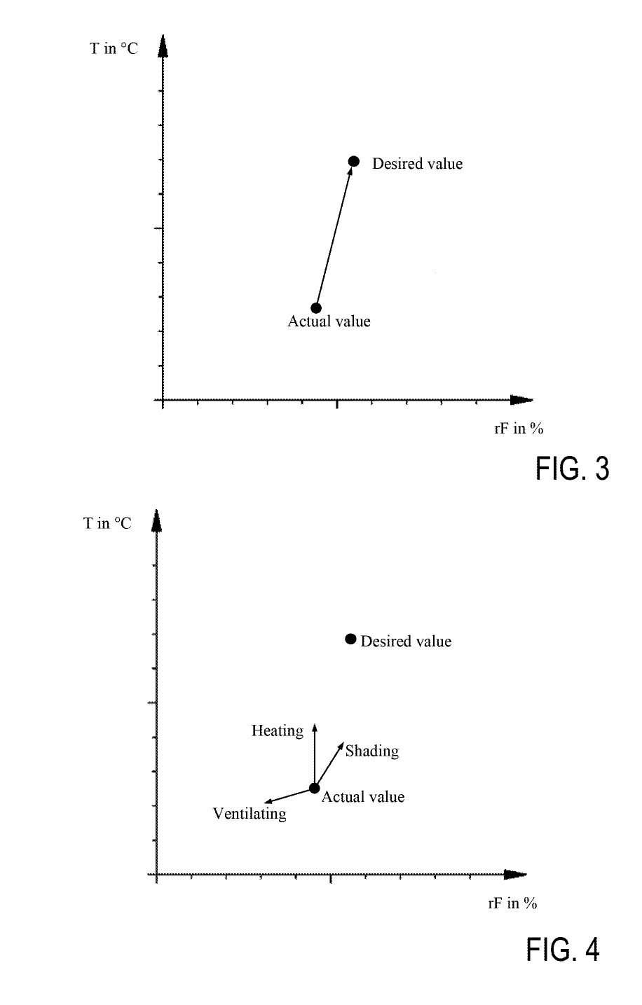

FIG. 3 a coordinate system with an actual value and a desired value and a measure vector, in order to proceed from the actual value to the desired value, for exemplary illustration of the principle of the invention,

FIG. 4 a coordinate system with an actual value, a desired value and various measure vectors, in order, under given marginal conditions, to proceed from the actual value to the desired value, for exemplary illustration of the principle of the invention,

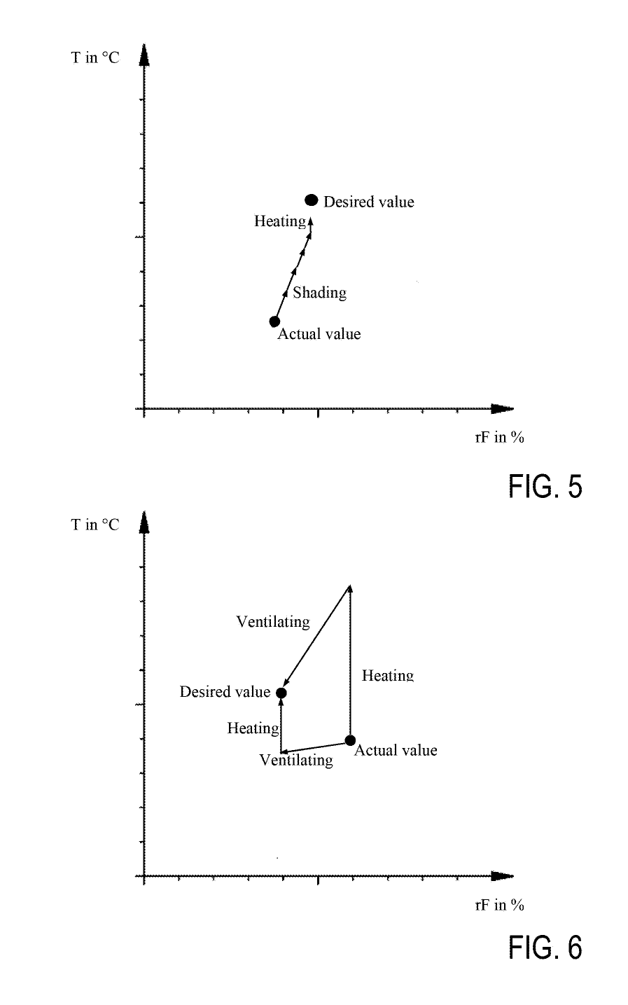

FIG. 5 a coordinate system with an actual value, a desired value and various measure vectors, in order, under given marginal conditions, to proceed from the actual value to the desired value, for exemplary illustration of the principle of finite iterative determination according to the invention,

FIG. 6 a coordinate system with an actual value, a desired value and various measure vectors, in order, under given marginal conditions, to proceed from the actual value to the desired value, for exemplary illustration of the principle of the invention, and

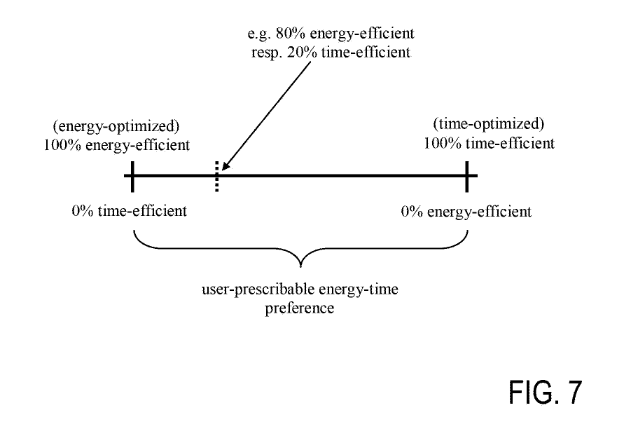

FIG. 7 a schematic representation for exemplary illustration of the principle of the invention of the user-prescribable preference.

FIG. 1 shows an exemplary embodiment of an operating method according to the invention for a building or house automation system in the form of a flow chart.

In a step S1 a user command is read in. The user command in step S1 specifies which building zone climate or which building zone climate change in the building zone should be achieved and preferably maintained. The user can, for example, prescribe a desired air temperature (e.g. 20° C.) or, for example, a desired temperature change (e.g. an increase by 3° C.). Reference will just be made in the following to the “building zone climate” to keep the text short, wherein, however, alternatively or additionally, the “building zone climate change” is also included.

It is possible for the user to make a plurality of prescribed specifications, for example a desired temperature and a desired air humidity. The user can, furthermore, for example, select a preferably predefined building zone climate desired scenario which comprises a plurality of user prescribed specifications, for example a desired temperature and a desired air humidity.

In a step S2 a further user command is read in. The user command specifies the point in time (or in which time period) at which the building zone climate prescribed in Step 1 should be achieved. The user command can alternatively or additionally also prescribe that the prescribed building zone climate should be obtained in a time-optimized manner resp. as quickly as possible, in an energy-optimized manner resp. by using as little energy as possible or with which energy/time preference desired by the user the prescribed building zone climate should be obtained. The principle of the preference prescribable by the user is illustrated in FIG. 7. As shown in FIG. 7, the user-prescribable preference can range between including the energy-optimized (100% energy-efficient) and including the time-optimized (100% time-efficient) weighting and, for example, in end effect leads to the building zone climate to be achieved being obtained with a weighting of, for example, “80% energy-efficient” and “20% time-efficient”.

In a step S3.1 the required minimum time expenditure and the required minimum energy expenditure to obtain the desired building zone climate can be determined. The determination takes place using empirical information previously determined and collected in step S0 which describes how the building zone climate empirically behaves under given marginal conditions (for example external air temperature, insolation, radiant power, internal air temperature or other outdoor climate and building zone climate parameters) and under the effect of at least one measure for influencing the building zone climate (for example heating, ventilating, shading, etc.). The empirical information describes, while taking account of at least one measure for influencing the building zone climate, an actually performed (used) time expenditure and energy expenditure to obtain a certain building zone desired climate when starting from a building zone actual climate.

Although FIG. 1 does not show this, parameters are detected, read-in or made available in some other way which are taken into account by the determination. The parameters can, for example, comprise the air temperature, brightness, air humidity, wind force, cloud cover, energy consumption of at least one measure for influencing the building zone climate, weather data, possibly also weather forecast data, generally valid (for example date, time of the year, etc.) and user-specific calendar data (for example presence, absence, scheduled dates, etc.) as well as data which describe the status or the behavior of at least one measure (or its actuators) for influencing the building zone climate.

Alternatively or in addition to Step S3.1 at least one measure can be determined in a Step S3.2 which is suitable to achieve the user prescribed specifications read in in step S2. The determination takes place essentially in an identical manner to that in Step S3.1, so that one is referred to the description above in order to avoid any repetition.

In step S4 the user is shown the information determined in Step S3.1 resp. S3.2 whereupon the user can select in Step S5 how the air conditioning should performed, in particular by using which measure, whether energy-optimized, time-optimized, or with which preference with respect to the energy-time weighting, in as far as this does not already occur in Step S2.

In a Step S6 at least one measure for influencing the building zone climate is performed which is suitable to fulfill the user prescribed specifications. The carrying out of the at least one measure for influencing the building zone climate preferably occurs by means of controlling or regulating (for example by means of the determining unit 20 or a control unit not shown in FIG. 2) the actuators assigned to the measures dependent on the determined actuating variables. In this way the building zone climate to be achieved, which is prescribed by the user, can be obtained and maintained for as long as the user desires.

A feature which is not shown in the flow chart of FIG. 1 is that the operating method can determine a latest possible point in time at which at least one measure for influencing the building zone climate is to be activated in order to obtain the building zone climate to be achieved prescribed by the user at the time prescribed by the user, whereby superfluous climatic conditioning of the building zone is avoidable and therefore energy can be saved.

A further feature which is not shown explicitly in FIG. 1 is the autonomous execution and/or adaptation of at least one measure for influencing the building zone climate based on or reacting to currently detected, changing or at least currently changed marginal conditions, which is controllable using the determining unit 20 or a separate control unit, whereby the building zone climate to be achieved can also be obtained or maintained for changing marginal conditions (e.g. a temperature drop).

FIG. 2 shows a schematic representation for illustration of an exemplary embodiment of the operating method according to the invention and of the building automation system according to the invention. The exemplary embodiment shown in FIG. 2 is similar in part with the previously described exemplary embodiment so that one is referred to the above description to avoid repetition.

FIG. 2 is sub-divided into four sections, namely a generally valid/universal one, a building specific/building automation specific one, a user specific one and a physical one. The arrows describe the flow of data between the functional units or functional means of the building automation system.

The building specific/building automation specific section has a providing/collecting unit 10 which comprises a sub-unit 10.1 for building zone climate related change rates or for time expenditures for obtaining specific building zone climates while taking account of and assignment of specific measures for influencing the building zone climate. The providing/collecting unit 10 further comprises a sub-unit 10.2 for building zone climate related energy expenditures for obtaining specific building zone climates while taking account of and assignment of specific measures for influencing the building zone climate.

The generally valid/universal section comprises a determining/calculating unit 20 which has a sub-unit 20.1 for a room climatic calculation or determination model and a sub-unit 20.2 for simulation and/or strategy planning.

The user specific section comprises a read-in unit 30 for reading in user commands. The user commands can be a prescribed specification with respect to a building zone desired climate to be achieved, a desired time for the building zone desired climate to be achieved or with respect to an energy/time preference of the user which can be energy-optimized, time-optimized or which can lie inbetween.

The physical section preferably comprises measures with actuators for influencing the building zone climate (for example a heater, shading means, window opening/closing means, etc.) and sensors for detecting the building zone climate and the outdoor climate.

The determining unit 20 uses for determining data/information (empirical information) communicated by the providing unit 10, user commands/user information provided by the read-in unit 30 and data/information, preferably climate describing data/information, provided by the sensors (for example building zone air temperature, external air temperature, etc.).

Based on the data/information from the providing unit 10, the sensors and the read-in unit 30, the determining unit 20 can determine a required time expenditure and energy expenditure taking into account of given or expected marginal conditions. Alternatively or additionally the determining unit 20 can determine at least one measure for influencing the building zone climate which is suitable to fulfill the user prescribed specifications.

The information or the data determined by means of the determination unit 20 are used in order to control or regulate corresponding measures for influencing the building zone climate and, in particular, their actuators, preferably by means of communication of control or regulation data and/or actuating variables.

The evaluation of the empirical information is most efficient when a single measure or a change can be observed and detected under constant conditions. Since this is not always possible in the presence of users, calibration of various measures can be performed during a phase of absence under the given climatic marginal conditions. To do so a procedure can be provided which decides, while taking account of the already accumulated or determined empirical information, whether the current actual status can meaningfully add to the collection of empirical information and therefore is to be recorded or not.

The regulating model shown in FIG. 2 can be executed as a multivariable controller. A multivariable controller can control a plurality of mutually influencing input and output parameters according to a specific systematic. The input parameters are sensory detected values for describing the status of the building zone climate and status values of the actuators (feedback). The output parameters are concrete actuating variables for available measures for influencing the building zone climate (or their actuators).

The regulate or control processes are calculated in a multi-dimensional vector space in which each controllable building zone climatic parameter represents a dimension. The following description is restricted just to two dimensions for better understanding, which can be assigned, for example, to the building zone climatic parameters air temperature and air humidity, wherein however, also more or less than two dimensions are possible.

The process of regulating or controlling can also be described with the aid of vectors. Starting from a specific point in space (actual climate) a target should be reached on a path to be determined (desired climate).

The desired values (in particular the building zone desired climate to be achieved) are subsequently specified for the purpose of better understanding as one dimensional room climatic parameters (for example air temperature=20° C.) but can also be specified multi-dimensionally in order to define a desired value range.

FIGS. 3 to 6 show coordinate systems where the vertical axis shows the building zone climate air temperature T in C.° and the horizontal axis shows the relative air humidity rF in %.

In FIG. 3 a building zone climatic actual value is marked as a point in the space whose position is defined by the measurement values detected by the sensors. The actual value is influenced by outer and inner marginal conditions (for example the weather, user interventions, thermal inertia of the building or the building zone). These influences act as vector values which cause a shift of the actual value away from or towards the target range.

As shown in FIG. 4, various different measures are available for influencing the building zone climate in order to adapt the actual value to the desired value, which can have an influence on one or more building zone climatic parameters. The measures available for influencing the parameters (heating, ventilating, etc.) can have very different effects on the building zone climate depending on the marginal conditions they are operating under. For example natural ventilation (for example over a window) equalizes the air temperature in the building zone with that of the external air temperature. If the external air temperature is lower than the air temperature in the building zone, the ventilation leads to cooling, or if higher leads to heating of the building zone. These effect relationships are essentially generally valid and can therefore be stored in a numerical control model. In the control model it is possible based on the numeric modelling of the effect relationships to determine the direction of the effect of a measure vector under the given marginal conditions.

As shown in FIG. 5, various solutions can be found for shifting the actual value in the direction of the desired value depending on which measures are used with which intensity, with which duration and in which sequence or combination.

The different solutions differ, in particular, in that how much time is required to reach or maintain the target and how much energy must be expended for this overall. This differentiation has hitherto practically been impossible, since no statement could be made without an extensive previously used computer simulation of the structural physical building behavior, how much time or energy a single measure requires in order to obtain a desired effect. Without determination of the necessary effecting times it is also not possible for energy consumption calculation to be carried out.

However, as has already been described above, it is possible using the invention to determine and to predict how much time or energy one or more measures for influencing the building zone climate is required under given marginal conditions and/or under at least one effect of at least one measure for influencing the building zone climate in order to obtain or maintain a building zone desired climate to be achieved when starting from a building zone actual climate.

This can, in particular, be achieved in that the adaptation rate (the change which a measure can effect on a room climatic parameter in a certain time) is determined. The change rate is building zone specific and/or building automation specific (for example thermal inertia, maximum air change rate for natural ventilation, maximum achievable brightness at 0% shading, maximum performance capability of the measures for influencing the building zone climate, etc.) and can be determined empirically by the control systematic according to the invention, preferably during operation. To do so the effect(s) of a measure on the change of a building zone climatic parameter (for example Kelvin per minute) is sensory detected during operation and associated to the given outer and inner marginal conditions (for example external temperature, radiant power). These data can be supplemented by automatically obtainable information (for example date, weather forecast, etc.). From the data sets so acquired it is possible to deduce building zone specific properties or characteristic values and to save them as empirical information in the providing unit 10.

According to the invention it is possible, in the course of operation or over the time, to continuously “learn” and preferably continuously refine the characteristic of the building zone, particularly the climatic behaviour, advantageously without the building-specific data (for example room volumes, masses etc.) having to be acquired and stored through an extensive process.

If the change rate of a measure is known under the given marginal conditions, then the period of the control processes can be approximated. Simultaneously, information is stored about the energy consumption of each measure which has been detected by means of sensors or can be entered manually. In this way the invention can be used to make a statement about which measure (actuatorics) has which effect on which room climatic parameter, with which speed it is changed and with which energy expenditure this change is associated.

Therefore the measures can be evaluated according to their time and energy efficiency and selected accordingly. Their effectiveness with respect to reaching the desired climate can be represented over the length of the measure vector in the control model. Here the vector length can vary strongly according to whether the time efficiency (speed) or the energy efficiency is taken as the criterion for the change achieved by the measure. Therefore the length and direction of the vector provide information about what degree of effectiveness the measure has with respect to reaching the desired climate.

In this way different strategies or possible solutions for achieving the user prescribed specification(s) can be simulated, in which series or combination, period and intensity the measure should be instigated in order to find an optimal solution according to the prescribable weighting of energy and time (energy-optimized, time-optimized or something inbetween).

As shown in FIG. 5, the determination preferably takes place by means of a finite iteration and evaluation method which is carried out in a simulation function parallel to the control operation. Since each measure which is active for a specific time leads to a new building zone climatic situation and therefore also later measures can have other effects on the building zone climate, a simulated actual value (see also FIG. 2) can, in an iteration method, be passed on to the simulation function which corresponds to the desired value achieved with the previous iteration step. The potential effect vector of the measures is calculated in the next iteration step from that point onwards. Target of the iteration method is to find the optimal path with respect to the prescibable time-energy preference or at least one suitable measure for obtaining a desired value. If the simulation function brings one to an optimal solution strategy then the first package of actuating variables is passed on. Subsequently, the solution strategy is checked and, if necessary, corrected on the basis of the new actual values.

Based on FIG. 6 a further exemplary explanation will be given about how the control systematics or determination according to the invention functions.

### EXAMPLE 1

A plurality of measures must be performed (ventilating and heating) in order to reach the desired value (desired climate). The desired value should be reached in an as energy-efficient manner as possible (see FIG. 7). The external temperature lies below the building zone temperature.

Three action strategies come in principle into question as a solution, first ventilating then heating, first heating then ventilating or both simultaneously.

The determining unit 20 will determine the first strategy (first ventilating then heating) since, in this case, the resulting length of the sum of the individual vector lengths is the shortest and is therefore the most efficient.

If heating were undertaken first the period of heating would be longer since the greater energy loss through ventilating at high temperature would have to be compensated for.

If both measures were performed simultaneously, the effect vector of the heating would be significantly shorter and it would be necessary therefore to heat longer and more intensively in order to reach the desired value.

### Example 2

The user has chosen an energy-efficient operating mode (for example energy-optimized or 100% energy-efficient as described in FIG. 7). The user opens a window although the heater is in operation. The heating power would have to be increased in order to maintain the desired value (desired climate). The control systematics according to the invention would switch off the heater in this example since it is not predictable that the desired value could be reached in an energy-efficient manner in the future. Still, the user would not feel to be overruled by switching off of the heater since he himself previously chose the preference “energy-optimized” (or had at least strongly set to energy efficiency).

If the weighting of the energy efficiency is minimized (for example 50% energy-efficient and 50% time-efficient as described in FIG. 7) then this can lead to the situation that the heater continues to be activated. Through establishing his preference with respect to time efficiency and/or energy efficiency the user accepts the energy loss associated with ventilating.

The exemplary embodiments and/or the features described above can be combined with one another in any desired way. The invention is not limited to the preferred exemplary embodiments described above. Instead, a plurality of modifications and variants are possible, which also make use of the concept of the invention and thus fall within the scope of protection. Furthermore, the invention also claims protection for the subclaims and their features independently of the features of the claims to which they refer.

1. An operating method for a building automation system, preferably for air conditioning of at least one building zone, in particular for controlling or monitoring at least one measure for influencing the building zone climate or at least one functional means of the building automation system, wherein the operating method comprises the following steps:
providing and/or collecting (S0) of at least one information, which describes at least one performed time expenditure and/or energy expenditure for obtaining or maintaining at least one specific building zone climate and/or at least one specific building zone climate change,
using the at least one information, determining (S3.1) and preferably displaying at least one required time expenditure and/or energy expenditure for obtaining or maintaining at least one building zone climate to be achieved or already achieved and/or at least one building zone climate change to be achieved or already achieved, and/or
using the at least one information, determining (S3.2) at least one measure for influencing the building zone climate with which at least one building zone climate to be achieved or already achieved and/or at least one building zone climate change to be achieved or already achieved can be obtained or maintained in a time-optimized and/or energy-optimized manner or can be obtained or maintained with a user-prescribable preference.

2-34. (canceled)
